(19) United States
(12) Patent Application Publication
(10) Pub. No.: US 2012/0306230 A1
(43) Pub. Date: Dec. 6, 2012

(54) DISPLAY DEVICE FOR A CONTROL PANEL FOR A MOTOR VEHICLE

(75) Inventors: Tan Duc Huynh, Neuilly-Sur-Marne (FR); Henry Beraud, Vincennes (FR)

(73) Assignee: VALEO SYSTÈMES THERMIQUES, Creteil Cedex (FR)

(21) Appl. No.: 13/510,503

(22) PCT Filed: Nov. 19, 2010
(86) PCT No.: PCT/FR10/00777

§ 371 Date: Aug. 2, 2012

(30) Foreign Application Priority Data
Nov. 20, 2009 (FR) 0905589

(51) Int. Cl. B60K 37/02; F16J 15/02; G02F 1/13; B60K 35/00

(52) U.S. Cl. 296/70

(57) ABSTRACT

The present invention relates to a display device (100) for a control panel for a motor vehicle, comprising opening (111) at which a display screen (130) is located, characterized in that the display device (100) comprises a seal (120) placed on at least a portion of the periphery of the opening (111).

The present invention relates to a display device for a control panel of an automobile. More specifically, the present invention aims to improve the seal-tightness of a display device present on a front panel of a control panel of an automobile. Its main aim is to secure the operation of various equipment items controlled by a user from the control panel.

The field of the invention is, generally, that of the protection of electronic components present in the control panel.

An automobile is commonly equipped, in the dashboard, with one or more equipment items. These equipment items are, for example: a car radio, an air-conditioning installation contained inside the passenger compartment of the vehicle or even a navigation system. The equipment items concerned are, more often than not, comfort equipment items, that is to say optional appliances which are not essential to a primary or crucial function of the vehicle, namely its movement. The control panels of these equipment items are often equipped with display devices which enable a user, via a dedicated screen, to be apprised of information relating to the equipment item concerned.

Thus, many current equipment items include control panels comprising one or more screens, notably liquid crystal display (LCD) screens, or screens which, for example, use a so-called TFT or “thin-film transistor”, technology, for thin film transistor matrices. The control panels may also include other types of screen, for example vacuum fluorescent display (VFD) screens.

A control panel typically consists of:
a front panel, forming the part of the equipment item that is visible to the user;
a screen, inscribed in the front panel, for example LCD, enabling information to be displayed;
a light box comprising, for example, LEDs or lamps and enabling an LCD-type screen to have sufficient light energy for a satisfactory display of the information;
a printed circuit comprising electronic components; and
a zebra or other pins or ribbon cable connection, providing the electrical contact between the screen and the printed circuit.

The various elements that have just been cited are fitted in such a way as to maintain a certain pressure so that the screen is bearing on the front panel of the control panel. The pressure exerted by the elements does, however, allow air to pass between the screen and the front panel of the control panel of the appliance.

When a user, charged with static electricity, moves his or her finger toward the front panel of an appliance, a discharge occurs because of a potential difference that exists between the finger and the front panel. In practice, the air situated between the front panel and the screen conducts the static electricity of the user at 1 kilovolt per millimeter. In summer, when the air is drier, the potential difference can be as high as 25 kilovolts, and thus be discharged over a distance of 25 millimeters.

Various systems for attracting the static electricity to protect the electronic components of the printed circuit exist; a system is, for example, known that involves the use of metal sheets: the metal sheets are placed above the areas connected to the screen. When an electrostatic discharge occurs, the electricity is attracted by the plate and is directly conducted to the ground. This system protects the electronic components, thus preserving the appliance as a whole, and extending its lifetime.

The major drawback with this system is that the metal plates are not distributed entirely around the contour of the appliance; the static electricity is thus attracted by the plates, but it can also take another path and damage the electronic components. One solution would be to place a plate metal frame over all of the contour but, for cost reasons, this solution is unsatisfactory. Furthermore, the arrangement of the plate around all of the screen is bulky. As explained previously, the static electricity conveyed by the user is damaging to the electronic components. If the electronic components of the control panel, or the connections, are located at a distance less than twenty-five millimeters from the front panel of said control panel concerned, which is the case of the printed circuit and of the connectors linking the LCD screen to the card and which are capable of conducting this strong overvoltage to the components, they are then likely to be damaged or even destroyed.

Moreover, cleaning products contain increasingly aggressive chemical agents. When the user cleans the control panel of his or her vehicle, certain chemical agents penetrate into the control panel between the front panel and the screen and thus damage the connections of the LCD screen which are thin “I.T.O.” oxidizable metal tracks, the electronic components or the elements of said control panel.

Thus, the absence of a great seal-tightness between the front panel and the screen of the control panel is highly damaging in particular for the electronic components present in said control panel.

The object of the present invention makes it possible to resolve the various problems that have just been mentioned. Thus, in the invention, there is proposed a solution for ensuring a viable seal-tightness of display devices present on the control panels of an automobile, in order for neither the electrostatic discharges generated by the user, nor the chemical agents, to be likely to damage the electronic components of the equipment items of a vehicle; to this end, in the invention, it is proposed to add a seal at the level of the screen of the control panels.

The invention therefore essentially relates to a control panel for an automobile comprising a front panel in which an opening is produced in which is arranged a display screen, characterized in that a seal is arranged on at least a portion of the periphery of the opening to protect the electronic components located behind the front panel against the ingress of fluids and electrostatic discharges.

In addition to the main characteristics that have just been mentioned in the preceding paragraph, the control panel according to the invention can have one or more additional characteristics from the following:
the seal is arranged over all the periphery of the opening;
the seal is glued onto the screen;
the seal is glued onto the periphery of the opening;
the seal is held by a pressure exerted on a rear face of the screen;
the seal is arranged in a groove formed on the periphery of the opening;
the seal (120) is arranged by extrusion in the groove formed on the periphery of the opening (111);
the seal (120) is arranged by overmolding on the periphery of the opening (111);
the pressure exerted on the seal is produced by fastening means;
the screen is an LCD-type screen;
the seal is produced in a flexible material;
the flexible material is a silicone elastomer or a cellular foam made of plastic or rubber material.

The various additional features of the control panel according to the invention, inasmuch as they are not mutually exclusive, are combined according to all possibilities of association to obtain different exemplary embodiments of the invention.

The invention and its different applications will be better understood on reading the following description and on studying the accompanying figures.

These are presented as an indication only and are in no way limiting on the invention. The figures show:

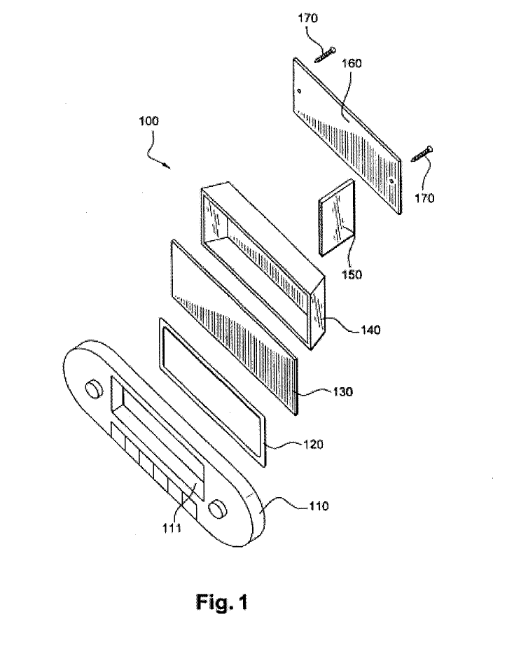

in FIG. 1, a representation of an exploded view of a control panel according to the invention;

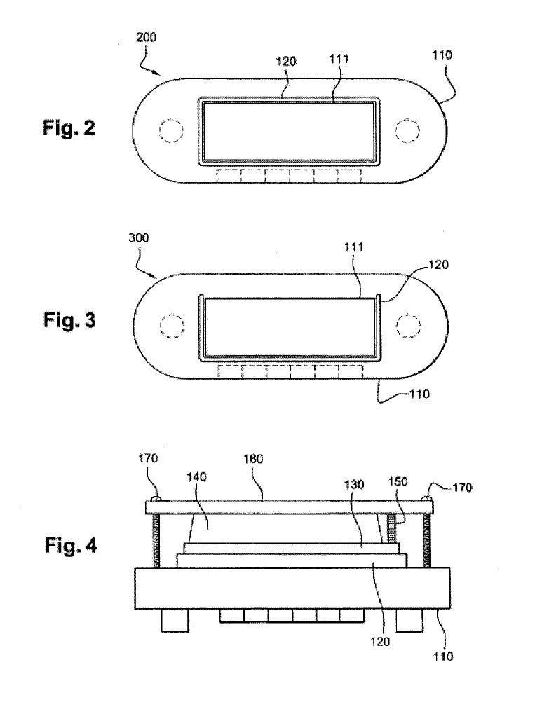

in FIG. 2, a representation of a first example of a control panel according to the invention;

in FIG. 3, a representation of a second example of a control panel according to the invention;

in FIG. 4, a representation of a control panel according to the invention seen from above.

The various elements that appear in different figures will, unless otherwise stipulated, retain the same references.

There are many equipment items likely to be present on a dashboard; purely as an example, in the following figures, a control panel will be described.

FIG. 1 represents an exploded view of a control panel 100 according to the invention.

The control panel 100 comprises a number of elements, in particular the following elements:
a front panel 110;
a seal 120;
a screen 130;
a light box 140;
a zebra elastomer connector 150;
a printed circuit 160;
and fastening means 170.

The front panel 110 is, in this description, a fixed part on which all the elements of said control panel 100 rest. Furthermore, the front panel 110 includes an opening 111 through which the information displayed on the screen 130 can be seen.

The seal 120 is situated between the front panel 110 and the screen 130. The seal 120 is produced in a flexible material, notably an elastomer material and more specifically a silicone elastomer. The chemical agents present in cleaning products are damaging to certain flexible materials. Silicone is a neutral material which can therefore not be damaged by the chemical agents. In this figure, the seal 120 is rectangular and has a size slightly greater than the periphery of the opening 111 in order not to be visible to the user.

The screen 130 is here an LCD-type screen; it is placed in front of the opening 111 of the front panel 110. The screen 130 displays the information that can be seen by the user.

The light box 140 is a white box which makes it possible to have the light diffused by the lamps or the LED diodes fixed onto the printed circuit 160 to be reflected and diffused uniformly.

The zebra circuit 150 provides a connection between the screen 130 and the printed circuit 160. The zebra circuit 150 is produced in a flexible material and it consists of thin blades providing the connections.

The fastening means 170 in this exemplary embodiment consist of screws passing through the printed circuit 160 and being screwed into the front panel 110, but may be produced in any other way.

The various elements of the control panel 100, described previously, bear on one another, thus making it possible to crush the seal 120 and ensure a seal-tightness so as not to allow air and/or chemical agents to pass.

In another embodiment, the fastening means is a rear cover of the front panel, said cover maintaining a pressure on all the elements of the control panel.

In a particular exemplary embodiment, the front panel 110 may form an integral part of the dashboard of the vehicle, by not constituting a part that is separate therefrom.

FIG. 2 represents a first control panel 200 according to the invention seen from behind, the front view corresponding to the part that is visible to a user.

The control panel device 200 comprises the various elements described with reference to FIG. 1.

In this example, the rectangular seal 120 is placed over all the periphery of the opening 111. Generally, the expression periphery of the opening 111 is used to designate the contour of said opening on which the seal 120 can bear.

The seal 120 is formed and glued directly either on the front panel 110 or on the screen 130, or on the front panel 110 and on the screen 130.

For example, in a groove formed behind the front panel, it is possible to deposit, via a programmed extrusion nozzle, over the surround, a pasty material, hardening or not, gluing or not, which will form the seal-tightness with the surface of the LCD.

Otherwise, it is also possible to provide an overmolding means which captures the front panel provided with a groove preformed by the injection operation or preceding sequence, and have the second liquid or pasty material, which will harden in the method to form the seal or the sealing lip, injected therein.

In other exemplary embodiments, the seal is first manufactured and is then alternatively:
glued onto the screen;
glued onto the front panel;
glued onto the front panel and the screen;
arranged between the front panel and the screen; it is then held with the pressure of the fastening means;
arranged in a groove previously formed on a portion of the front panel not visible to the user.

FIG. 3 represents a second control panel 300 according to the invention seen from behind.

The various elements that make up the control panel 300 remain unchanged compared to the first example described.

In this second embodiment, the essential difference from the first exemplary embodiment described lies in the fact that the seal 120 is placed on a portion of the periphery of the opening 111 of the front panel 110. The seal 120 is placed on the sides and on the bottom portion of said opening 111; it is thus “U” shaped.

In this embodiment, the protection of the electronic components is ensured because the critical area is here located at the connections or the control buttons represented by broken lines at the bottom of FIG. 3. On the one hand, cleaning products always have a tendency to run downward and are blocked by the seal and, on the other hand, the seal being located to the side of the control buttons can block electrostatic discharges upon the approach of the finger of the user. This example shows that it is not necessary to place the seal over the entire surround of the screen but that it can be placed only at the points necessary to guarantee a good protection of the electronic components.

FIG. 4 represents the control panel 200 according to the invention seen from above.

The elements present in FIG. 4 are represented as they will be assembled, that is to say before the screws 170 are screwed in.

1. A control panel for an automobile comprising:
a front panel in which an opening is produced, the front panel comprising in a display screen arranged therein,
wherein a seal is arranged on at least a portion of a periphery of the opening to protect a plurality of electronic components located behind the front panel against an ingress of fluids and electrostatic discharges.

2. The control panel as claimed in claim 1, wherein the seal is arranged over all the periphery of the opening.

3. The control panel as claimed in claim 1, wherein the seal is glued onto the display screen.

4. The control panel as claimed in claim 2, wherein the seal is glued onto the periphery of the opening.

5. The control panel as claimed in claim 1, wherein the seal is held by a pressure exerted on a rear face of the screen.

6. The control panel as claimed in claim 1, wherein the seal is arranged in a groove formed on the portion of the periphery of the opening.

7. The control panel (100) as claimed in claim 6, wherein the seal is arranged by extrusion in the groove formed on the portion of the periphery of the opening.

8. The control panel as claimed in claim 1, wherein the seal is arranged by overmolding on the portion of the periphery of the opening.

9. The control panel as claimed in claim 5, wherein the pressure exerted on the seal is produced by fastening means.

10. The control panel as claimed in claim 1, wherein the screen is an LCD-type screen.

11. The control panel as claimed in claim 1, wherein the seal is produced in a flexible material.

12. The control panel as claimed in claim 11, wherein the flexible material is a silicone elastomer or a cellular foam made of plastic or rubber material.
